(19) United States
(12) Patent Application Publication
(10) Pub. No.: US 2016/0186012 A1
(43) Pub. Date: Jun. 30, 2016

(54) ADHESIVE COMPOSITION, ADHESIVE COMPRISING THE SAME, AND METHOD OF FABRICATING ADHESIVE COMPRISING THE SAME

(71) Applicant: PIONEER MATERIAL PRECISION TECH CO., LTD., New Taipei City (TW)

(72) Inventors: Yong-Qi Cai, New Taipei City (TW); Yuan-Shun Tsai, New Taipei City (TW); Wei-Ting Lin, Taipei City (TW)

(21) Appl. No.: 15/065,880

(22) Filed: Mar. 10, 2016

Related U.S. Application Data
(63) Continuation-in-part of application No. 13/744,427, filed on Jan. 18, 2013, now abandoned.
(60) Provisional application No. 61/588,661, filed on Jan. 20, 2012.

(51) Int. Cl. C09J 7/02; C09J 11/04; C09J 183/04; C09J 9/00

(52) U.S. Cl. CPC C09J 7/0207; C09J 9/00; C09J 11/04; C09J 183/04; C09J 2483/00; C08K 3/22

(57) ABSTRACT

A thermally conductive, electrically insulating, high temperature resistant and flame retardant adhesive sheet includes a substrate, an adhesive layer disposed on the substrate, metal hydroxide and metal oxide. The adhesive layer is formed from an adhesive composition, which is made of from 10 to 90 wt. % of a solvent-free and pressure sensitive siloxane resin. The siloxane resin includes hydrophilic functional groups, and the weight percentage of the hydrophilic functional groups in the siloxane resin is in the range of 1 to 10 wt. %

### CROSS REFERENCE TO RELATED APPLICATIONS

This application is a continuation-in-part of U. S. application Ser. No. 13/744,427, filed on Jan. 18, 2013, which claims the benefit of U.S. provisional application Ser. No. 61/588,661, filed on Jan. 20, 2012. The entire contents of these related applications are incorporated herein by reference and made a part of this specification.

### BACKGROUND OF THE INVENTION

1. Field of the Invention

The present invention relates generally to a novel composition, which is thermally conductive, electrically insulating, high temperature resistant and flame retardant, and an adhesive sheet containing this composition. In particular, the adhesive composition and the adhesive sheet are tested under a standard test for flammability, i.e. UL 94 test, and are able to be classified into the highest flame retardant group, i.e. UL 94V-0.

2. Description of the Prior Art

The general purpose of an adhesive composition is to make two objects firmly adhere to each other. The special adhesive composition may be used on computer motherboards. For example, the adhesive composition is used to make a heat-generating device firmly adhere to a heat-dissipating device. Also, the adhesive composition can be used to transmit heat from the heat-generating device to the heat-dissipating device.

There are already double-sided adhesives, which are commercially available and known as thermally conductive adhesives, to conduct the heat coming from the heat source to the heat-dissipating device. These thermally conductive and double-sided adhesives are generally substrates coated with acrylic-based adhesive. However, since the main ingredients of the adhesives are acrylic-based organic compounds, these thermally conductive double-sided adhesives have drawbacks. For example, it is neither high temperature resistant (not over 100° C. in general) nor flame retardant. Also, the thermally conductive property is not good enough.

In addition, although there are also commercially available double-sided and thermally conductive adhesives with silicone-coated substrates, and they are temperature resistant (not over 180° C. in general) , but these silicone-based adhesives are not flame retardant. Also, although there are many commercially available thermally conductive adhesives, the mechanical property of the adhesives is still not high enough due to its thin thickness.

Accordingly, there is still a need to provide a composition and an adhesive sheet which are thermally conductive, electrically insulating, high temperature resistant and flame retardant. Moreover, they should pass the standard test for flammability, i.e. UL 94 test, and be classified into the highest flame retardant group, i.e. UL 94V-0.

### SUMMARY OF THE INVENTION

In view of the above, the present invention discloses an adhesive composition, which is thermally conductive, electrically insulating, high temperature resistant and flame retardant, and an adhesive sheet containing this composition. The features of the composition and the adhesive sheet of the present invention are that they are not only highly thermally conductive and electrically insulating, but also rated to the specification of UL 94V-0 standard, which is fully able to meet the strict and stringent industrial demands.

According to one embodiment of the present invention, a thermally conductive, electrically insulating, high temperature resistant and flame retardant adhesive sheet is disclosed and includes a substrate, an adhesive layer disposed on the substrate, metal hydroxide and metal oxide. The adhesive layer is formed from an adhesive composition, which is made of from 10 to 90 wt. % of a solvent-free and pressure sensitive siloxane resin. The siloxane resin includes hydrophilic functional groups, and the weight percentage of the hydrophilic functional groups in the siloxane resin is in the range of 1 to 10 wt. %.

According to another embodiment of the present invention, a method of fabricating a thermally conductive, electrically insulating, high temperature resistant and flame retardant adhesive sheet is disclosed. First, at least a layer of vinyl-functional coupling agent is coated on the surface of a substrate. A mixture made by mixing a solvent-free siloxane, a metal hydroxide and a metal oxide is then coated on the surface of the substrate. The composition of the solvent-free siloxane includes at least a hydrophilic functional group, and the weight percentage of the hydrophilic functional group in the solvent-free siloxane is in the range of 1 to 10 wt. %. Finally, the substrate is heated so as to cure the mixture coated on the substrate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a method of forming a single-sided adhesive sheet with a substrate according to an embodiment of the present invention.

FIG. 2 illustrates a single-sided adhesive sheet with extremely small thickness according to an embodiment of the present invention.

FIG. 3 illustrates a single-sided adhesive sheet according to an embodiment of the present invention.

FIG. 4 illustrates a double-sided adhesive sheet with very small thickness and without a substrate according to an embodiment of the present invention.

FIG. 5 illustrates a double-sided adhesive sheet with a substrate according to an embodiment of the present invention.

FIG. 6 illustrates a double-sided adhesive sheet according to an embodiment of the present invention.

FIG. 7 illustrates a double-sided adhesive sheet according to an embodiment of the present invention.

FIG. 8 illustrates a single-sided adhesive sheet according to an embodiment of the present invention.

FIG. 9 illustrates a double-sided adhesive sheet according to an embodiment of the present invention.

### DETAILED DESCRIPTION

The present invention provides a thermally conductive, electrically insulating, high temperature resistant and flame retardant composition and an adhesive containing the composition. The adhesive of the present invention contains at least a silicon oxide resin, a metal hydroxide and a metal oxide, and optional nitride or aluminum powder. In addition, a coupling agent based on silane is optionally employed when a silicon-free substrate is used.

The siloxane resin is used as the carrier for the high temperature resistant property, and the metal hydroxide as well as the metal oxide may be used to enhance the flame retardant property. At least one of the nitride and aluminum powder may be used to enhance the thermally conductive property. The coupling agent such as silane may be used alone or mixed with a solvent to form the chemical bonding with the silicon-free substrates to enhance the bonding strength. When the metal oxide is present in a higher ratio, it is possibly more thermally conductive and flame retardant. Preferably, the composition in the adhesive of the present invention may be not fully cured to be sufficiently sticky.

The siloxane resin may be 10% to 90% by weight of the overall adhesive composition, preferably from 20% to 50% by weight. These siloxane resins are materials which are able to withstand a temperature above 150° C. without substantially cracking at a temperature around 150° C., and its hardness does not substantially change with a change of the temperature. The term “substantially” used in the present invention is considered as the overall hardness change of the siloxane resin less than 10 degrees (shore A) as the temperature changes, which meets the international standard of UL157 of 0-ring and sealing gasket. In other words, the functions of the adhesive composition are not deteriorated accordingly. Supposing the change of the hardness of the thermoplastic material is within ±10 degrees, the function of the material is not compromised. The siloxane resin may be the products from USA MOMENTIVE™ (GE), USA Dow Corning® or Japan Shin-Etsu. For example, the MOMENTIVE™ series, which is used in pressure sensitive adhesives (PSA series), may be the siloxane resin for use in the present invention. Preferably, the siloxane resins are solvent-free and pressure sensitive siloxane resins and includes hydrophilic functional group. The weight percentage of the hydrophilic functional group in the solvent-free and pressure sensitive siloxane resin is in the range of 1 to 10 wt. %. The hydrophilic functional group is selected from the group consisting of a hydroxyl group, a silanol group, a carboxyl group, and an amino group, but not limited thereto. As an example, the solvent-free and pressure sensitive siloxane resins may be resins of MOMENTIVE™ PSA series, such as Silopren Gel 8-5900-PSA. The term “solvent-free siloxane resin” means that the siloxane resin contains less than 3 wt. % of solvent, and preferably contains no solvent. By using the solvent-free siloxane resin as the main component of the adhesive layer or sheet, the adhesive layer or sheet can show better flame-retardant property compared with convention adhesive layers or sheets.

The metal hydroxide may be 0.01% to 75% (wt.) of the overall adhesive composition, preferably from 20% to 50% by weight. The metal hydroxide generates water and a corresponding metal oxide when heated. The metal hydroxide may be, for example, at least one of zinc hydroxide, aluminum hydroxide and magnesium hydroxide. The metal hydroxide helps to improve the flame retardant property of the overall adhesive composition.

The metal oxide may be 0.01% to 80% (wt.) of the overall adhesive composition, preferably from 20% to 50% by weight. The metal oxide may be a main group metal oxide or a transition metal oxide, such as at least one of alumina (aluminum oxide), zinc oxide and magnesium oxide. The metal oxide helps to improve the thermally conductive, flame retardant and electrically insulating properties of the overall adhesive composition.

The optional nitride may be 0.01% to 30% (wt.) of the total adhesive composition, preferably from 10% to 20% by weight. The nitride may be a metal nitride, or a non-metal nitride, which helps to improve the thermally conductive property of the overall adhesive composition. For example, aluminum nitride or boron nitride may be added to the siloxane resin to make it more thermally conductive. The aluminum nitride has a thermal conductivity of 70˜210 W/mK in the form of poly crystalline, and the single crystal boron nitride has a thermal conductivity about 100 W/mK.

The aluminum powder may be 0.01% to 3% by wright in the total adhesion composition, preferably from 0.5% to 1% by weight. The aluminum powder of high purity, high sphericity and less oxidized status may has an average particle size between 1 micrometer to 50 micrometers. The aluminum powder may have a heat transfer coefficient about 230 W/mK and helps to improve the thermally conductive property of the overall adhesion composition.

The optional coupling agent may be 0.01% to 5% by wright in the total adhesion composition, preferably from 1% to 3% by weight.

The coupling agent mainly functions to enhance the interaction between the siloxane resin and a non-silicone substrate. The coupling agent may be a silane with single component such as from USA MOMENTIVE™ (GE), USA Dow Corning®, Japan Shin-Etsu or Germany Degussa AG, or a blended silane coupling agent with a solvent. The solvent may be toluene, xylene, isopropanol, butanone or ISOPAR®. The silane-based coupling agent may combine the silane layer with the non-silicone substrate through a hydrolysis reaction. The cross-linking reaction helps to enhance the interaction between the siloxane resin and a non-silicone substrate. Preferably, the coupling agent is a silane-based coupling agent mainly composed of vinyl-tris(2-methoxyethoxy)silane, vinyl-trimethoxy or gamma-glycidoxypropyl trimethoxy silane, but is not limited thereto.

After appropriately formulated, the adhesive composition of the present invention is thermally conductive, electrically insulating, high temperature resistant and flame retardant at the same time. The formulation may be done by a closed mixer or an open mixer. The thermal resistance of the adhesive composition may be less than 5° C./w, and the thermal conductivity may be well adjusted in accordance with the addition of different ingredients. The volume resistivity of the adhesive composition is at least greater than 10⁸ ohm-cm, usually greater than 10¹¹ ohm-cm, preferably greater than 10¹⁴ ohm-cm. The adhesive composition of the present invention is rated to an international standard, such as the specification of UL 94V-0.

UL 94V is the international standard test for flammability of plastic materials for parts in devices and appliances. It rates the plastic and rubber flammability by judging the afterflame time, afterglowtime, burning rate and the falling flaming particles or drops. The term “afterflame” means persistence of flaming of a material, after the ignition source has been removed, and the term “afterflame time” is used to indicate the length of time for which a material continues to flame, under specified conditions, after the ignition source has been removed. In addition, the term “afterglow” means persistence of glowing of a material, after cessation of flaming or, if no flaming occurs, after removal of the ignition source. The term “afterglow time” indicates the length of time for which a material continues to glow under specified test conditions, after the ignition source has been removed and/or cessation of flaming.

Furthermore, the tested materials can be classified to three classes, V-0, V-1, and V-2, and the V-0 class is the highest class in the test. If a material is classified in the UL 94V-0 class, its afterflame time for each individual specimen is less than 10 seconds, its total afterflame time for any condition set consisting of 5 specimens is less than 50 seconds, its afterflame plus afterglow time for each individual specimen after the second flame application is less than 30 seconds, afterflame or afterglow of any specimen up to the holding clamp would not be happened, and a cotton indicator under the specimen would not be ignited by flaming particles or drops of the specimen. Because the details of UL 94V-0 are available to the public, these details are omitted for the sake of simplicity.

Optionally, the layer of adhesive composition as well as the adhesive sheet of the present invention may have an extremely small thickness. For example, the thickness of the layer of the adhesion composition may be between 0.05 mm to 20 mm, typically between 0.5 mm to 0.05 mm, preferably between 0.2 mm to 0.05 mm. Therefore, the adhesive composition of the present invention may forma single-sided or a double-sided adhesive sheet with extremely small thickness.

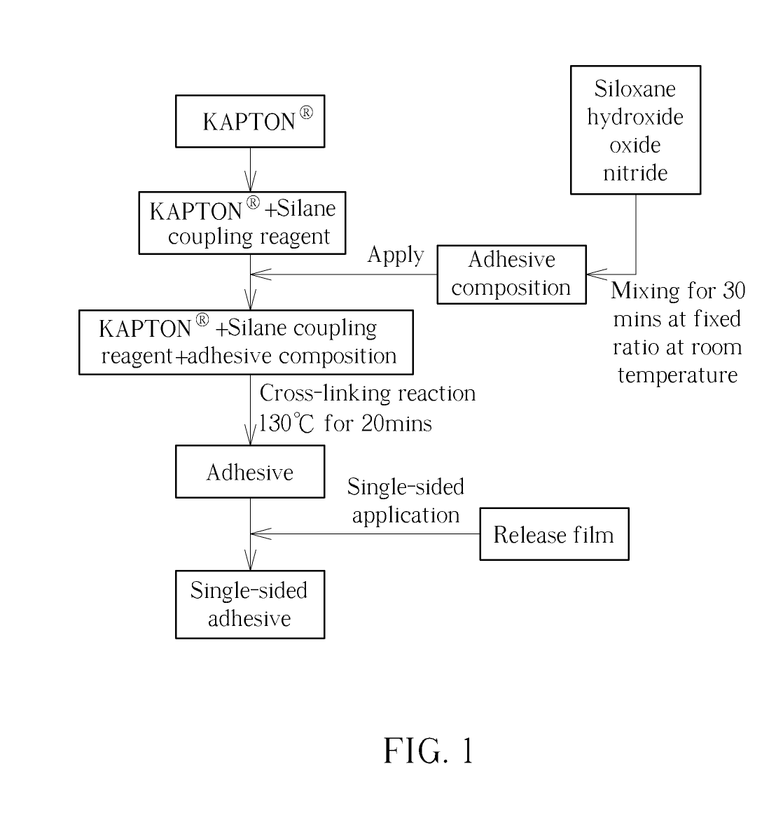

FIG. 1 illustrates the method to form a single-sided product of the adhesive composition of the present invention to go with a substrate, such as KAPTON®. First, a layer of silane coupling agent is applied on one side of a KAPTON® substrate and dried at room temperature. After that, a layer of an adhesive composition of the present invention which has been pre-formulated is uniformly applied on the silane-based coupling agent coated on the substrate. The adhesive composition of the present invention may have, for example, 50 wt. % of siloxane resin, 30 wt. % of alumina, 18 wt. % of aluminum nitride and 2 wt. % of silane-based coupling agent. Besides, the viscosity of the solvent-free siloxane resin is in the range of 20 to 50 Pa·s. Next, it is placed in an oven at 130° C. for 20 minutes to undergo a cross-linking reaction. Afterwards, it is taken out and a release film is applied on.

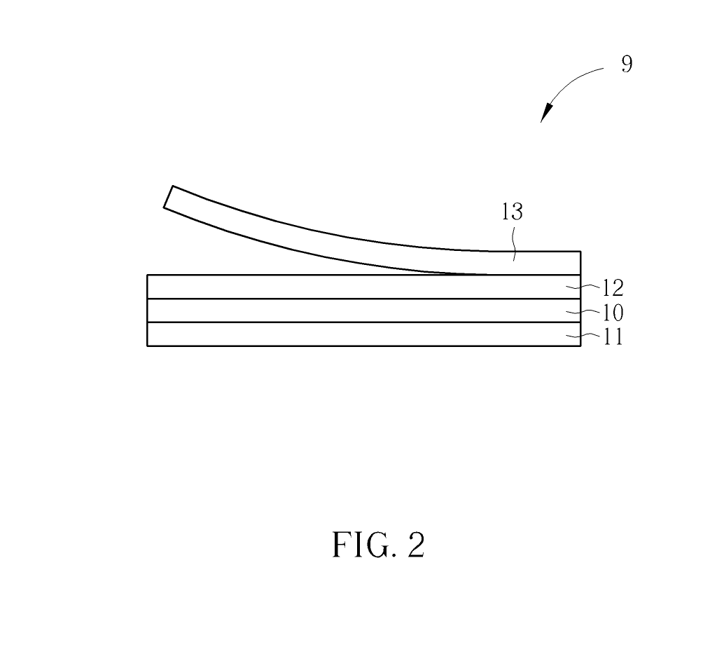

In one embodiment of the present invention, the adhesive of the present invention may form a single-sided product of extremely small thickness. FIG. 2 illustrates a single-sided adhesive sheet with extremely small thickness of the present invention. The adhesive sheet 9 of the present invention includes a substrate 11, an adhesive composition 12 and a release film 13. The element 10 is a silane-based coupling agent. The substrate 11 may be a metal foil of excellent thermally conductive property, such as aluminum foil. Please refer to the above for the details of the adhesive composition 12. The total thickness of the substrate 11 and the adhesive composition 12 can be as small as about 0.05 mm. The coupling agent 10 helps to strengthen the adhesion between the adhesive composition 12 and the non-silicone substrate 11.

The adhesive composition 12 covers one side of the substrate 11, and the release film 13 covers the other side of the adhesion composition 12, so that the adhesion composition 12 is sandwiched between the substrate 11 and the release film 13. Tear the release film 13 off to adhere the adhesive composition 12 to a target object (not shown). FIG. 2 illustrates an adhesive sheet 9 of the present invention, which has the substrate 11 of excellent thermal conductivity property, particularly suitable for a heat source of continuous high temperature and for use in high thermally conductive purposes, such as the motherboards of computers, central processor units or power supplies to bind the heat source and the heat sink.

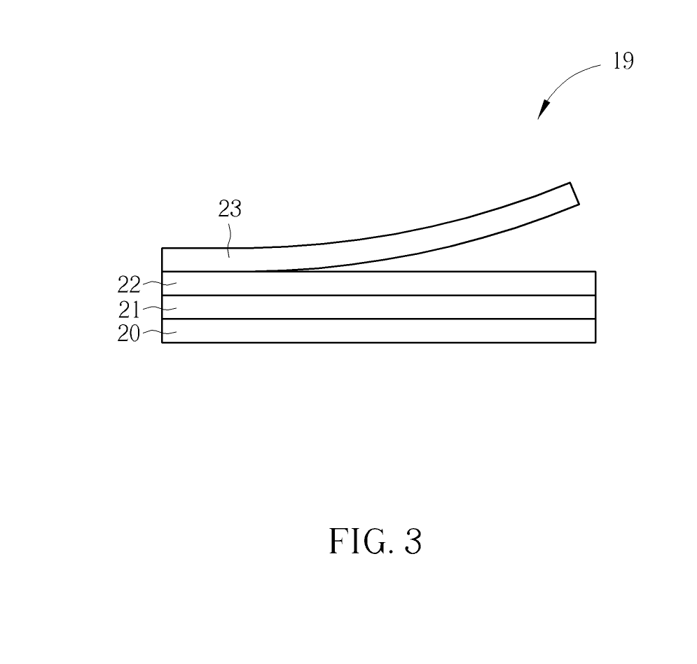

In another embodiment of the present invention, the adhesive sheet of the present invention may form another single-sided adhesive product. FIG. 3 illustrates a single-sided adhesive sheet of the present invention. The adhesive sheet 19 of the present invention includes a substrate 20, a layer of an adhesive composition 22 and a release film 23. The element 21 is a silane-based coupling agent. The substrate 20 maybe an organic polymer, preferably a thermal stable, high electric resistant and robust organic polymer, for example KAPTON®, which is basically a polyimide (PI) insulating film or tape, a trademark of DuPont Inc. KAPTON® is highly flexible, puncture-proof, and has good electrical properties. Alternatively, other commercially available polyimide materials will do, too. If the substrate is required to withstand a temperature no more than 80° C. to 150° C., commercially available polyethylene terephthalate (PET) or polycarbonate (PC) material maybe considered as the substrate. Please refer to the above for the details of the adhesive composition 22. The coupling agent 21 is used to strengthen the adhesion force between the adhesive composition 22 and the non-silicone substrate 20.

The adhesive composition 22 covers one side of the substrate 20, while the release film 23 coves the other side of the adhesive composition 22, so that the adhesive composition 22 is sandwiched between the substrate 20 and the release film 23. Tear the release film 23 off to adhere the adhesive composition 22 to a target object (not shown). FIG. 3 illustrates an adhesive sheet 19 of the present invention, which has the substrate 21 of high tensile strength, high tearing strength and withstand voltage property, is particularly suitable for the high voltage and high temperature purposes.

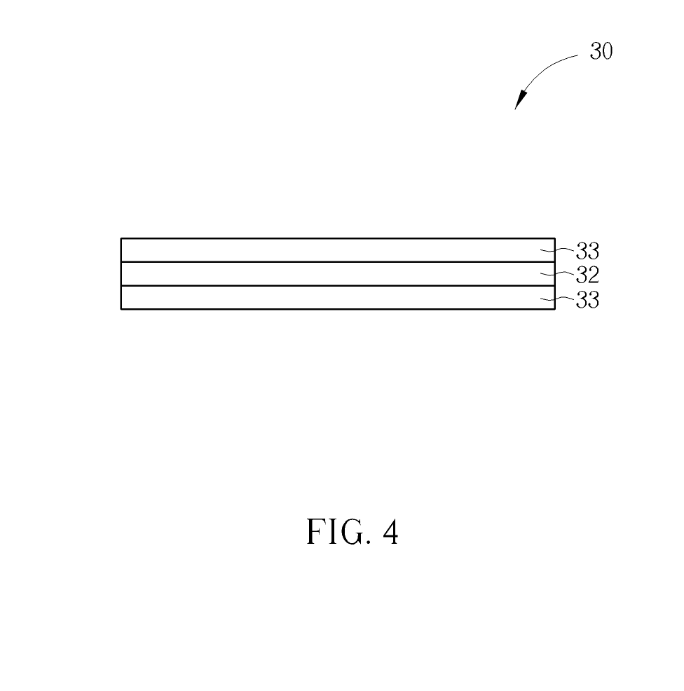

In another embodiment of the present invention, the adhesive of the present invention may form a single-sided adhesive product of a minimum thickness. FIG. 4 illustrates a double-sided adhesive sheet with very small thickness of the present invention. The adhesive sheet 30 of the present invention may contain nothing but an adhesion composition 32. The presence of the release film 33 is optional. Please refer to the paragraphs above for the details of the adhesion composition 32.

The release films 33 cover both sides of the adhesive composition 32 so that the adhesive composition 32 is sandwiched between the release films 33. Tear the release film 33 off to adhere the adhesive composition 32 to a target object (not shown). FIG. 4 illustrates an adhesive sheet 30 of the present invention which can be used without a substrate, and therefore particularly suitable for use in limited space.

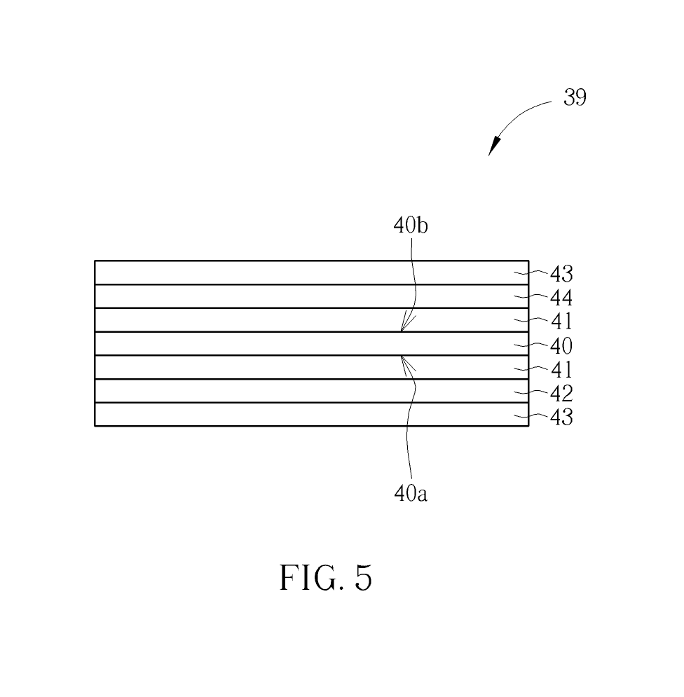

In another embodiment of the present invention, the adhesive of the present invention may also form a double-sided product with a substrate. FIG. 5 illustrates a double-sided adhesive sheet with a substrate. The adhesive sheet 39 of the present invention includes a substrate 40, a layer of a first adhesive composition 42, a second adhesive composition 44 and a release film 43. The element member 41 is a silane-based coupling agent. The substrate 40 may be a metal foil of excellent thermally conductive property, such as aluminum foil. Please refer to the above for the details of the first adhesive composition 42 and the second adhesive composition 44. The coupling agent 41 helps to strengthen the adhesion between the first adhesive composition 42 as well as the second adhesive composition 44 and the non-silicone substrate 40.

The first adhesive composition 42 and the second adhesive composition 44 respectively cover the first side 40a and the second side 40b of the substrate 40, so that the substrate 40 is sandwiched between the first adhesive composition 42 and the second adhesive composition 44. The release films 43 cover both the first adhesive composition 42 and the second adhesive composition 44 at the same time so that the substrate 40, the first adhesive composition 42 and the second adhesive composition 44 are also sandwiched between the release films 43. Tear the release film 43 off to respectively adhere the first adhesive composition 42 and the second adhesive composition 44 to a target object (not shown). FIG. 5 illustrates an adhesive sheet 39 of the present invention, which has the substrate 40 of excellent thermal conductivity property, particularly suitable for a heat source of continuous high temperature and for use in high thermally conductive purposes, such as the motherboards of computers, central processor units or power supplies to bind the heat source and the heat sink.

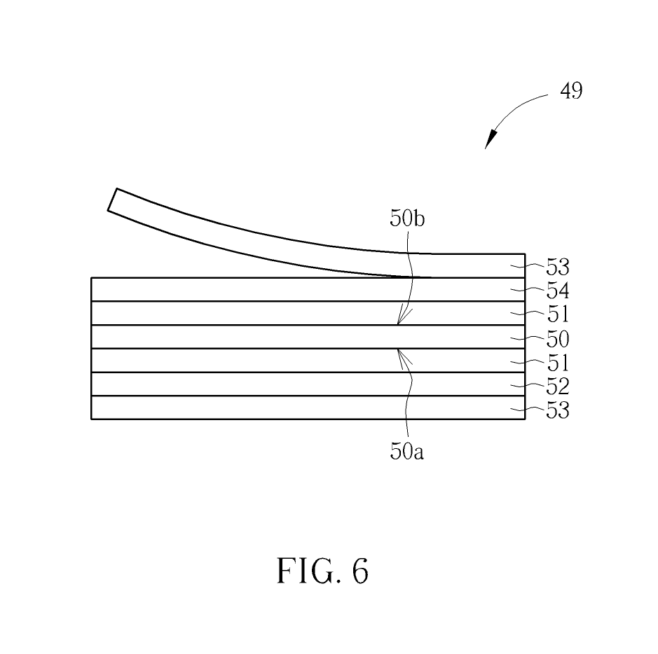

In another embodiment of the present invention, the adhesive of the present invention may also forma double-sided adhesive product with a substrate. FIG. 6 illustrates an adhesive sheet of the present invention forms a double-sided product with a substrate. The adhesive sheet 49 of the present invention includes a substrate 50, a layer of a first adhesive composition 52, a second adhesive composition 54 and a release film 53. The element 51 is a silane-based coupling agent. The substrate 50 maybe an organic polymer, preferably a thermal stable, high electric resistant and robust organic polymer, for example KAPTON®, which is basically a polyimide (PI) insulating film or tape, a trademark of DuPont Inc. KAPTON® is highly flexible, puncture-proof, and has good electrical properties. Alternatively, other commercially available polyimide materials will do, too. If the substrate is required to withstand a temperature no more than 80° C. to 150° C., commercially available polyethylene terephthalate (PET) or polycarbonate (PC) material may be considered as the substrate. Please refer to the above for the details of the first adhesive composition 52 and the second adhesive composition 54. The coupling agent 51 helps to strengthen the adhesion between the first adhesive composition 52 as well as the second adhesive composition 54 and the non-silicone substrate 50.

The first adhesive composition 52 and the second adhesive composition 54 respectively cover the first side 50a and the second side 50b of the substrate 50, so that the substrate 50 is sandwiched between the first adhesive composition 52 and the second adhesive composition 54. The release films 53 cover both the first adhesive composition 52 and the second adhesive composition 54 at the same time so that the substrate 50, the first adhesive composition 52 and the second adhesive composition 54 are also sandwiched between the release films 53. Tear the release film 53 off to respectively adhere the first adhesive composition 52 and the second adhesive composition 54 to a target object (not shown). FIG. 6 illustrates an adhesive sheet 49 of the present invention, which has the substrate 50 of high tensile strength, high tearing strength and withstand voltage property, is particularly suitable for the high voltage and high temperature purposes.

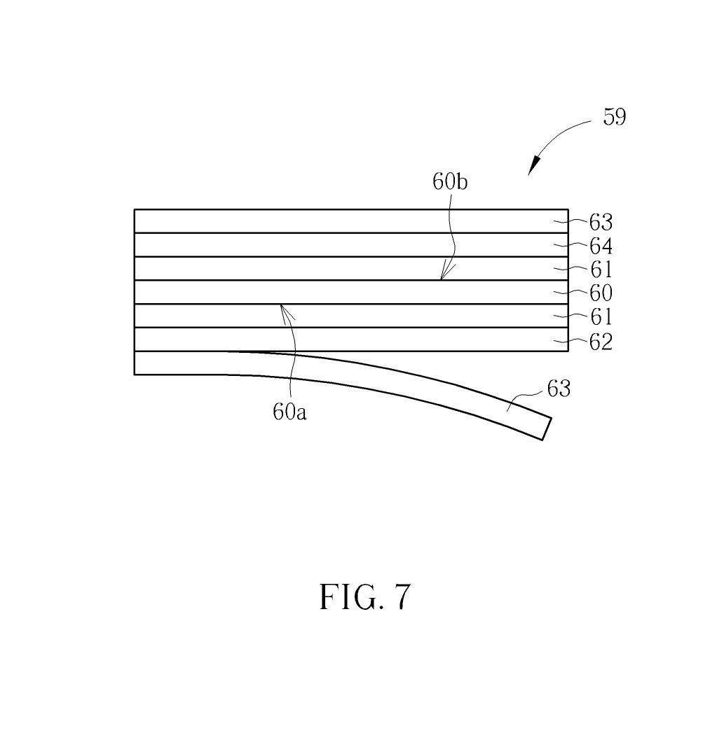

In another embodiment of the present invention, the adhesive of the present invention may also forma double-sided adhesive product with a substrate. FIG. 7 illustrates an adhesive sheet of the present invention forms a double-sided product with a substrate. The adhesive sheet 59 of the present invention includes a substrate 60, a layer of a first adhesive composition 62, a second adhesive composition 64 and a release film 63. The element 61 is a silane-based coupling agent. The substrate 60 maybe an inorganic material, preferably glass fiber. Glass fiber is dimensionally stable under high temperature, electrical resistant, flame retardant, and robust. Please refer to the above for the details of the first adhesive composition 62 and the second adhesive composition 64. The coupling agent 61 helps to strengthen the adhesion between the first adhesive composition 62 as well as the second adhesive composition 64 and the non-silicone substrate 60.

The first adhesive composition 62 and the second adhesive composition 64 respectively cover the first side 60a and the second side 60b of the substrate 60, so that the substrate 60 is sandwiched between the first adhesive composition 62 and the second adhesive composition 64. The release films 63 cover both the first adhesive composition 62 and the second adhesive composition 64 at the same time so that the substrate 60, the first adhesive composition 62 and the second adhesive composition 64 are also sandwiched between the release films 63. Tear the release film 63 off to respectively adhere the first adhesive composition 62 and the second adhesive composition 64 to a target object (not shown). FIG. 7 illustrates the adhesive sheet 59 of the present invention is particularly for use as strips because the substrate 60 is dimensionally stable under high temperature, electrical resistant, flame retardant, and robust.

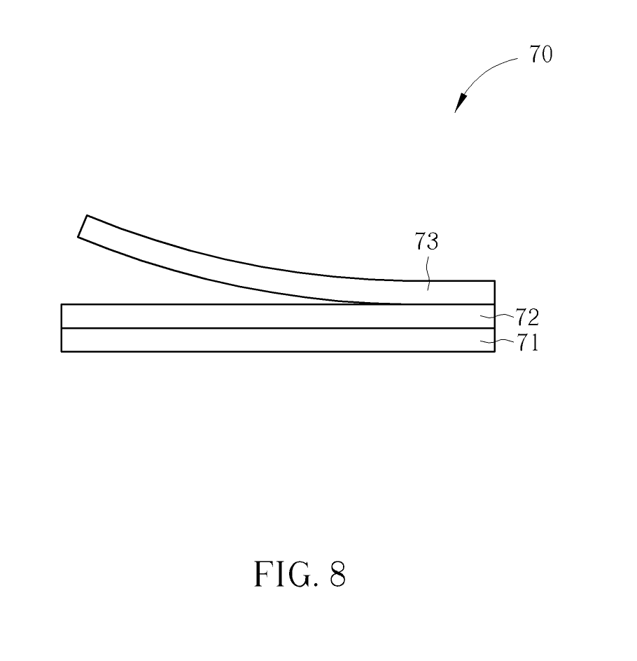

In another embodiment of the present invention, the adhesive of the present invention may forma compressible single-sided adhesive. FIG. 8 illustrates the adhesive sheet of the present invention forms a single-sided adhesive product. The adhesive sheet 70 of the present invention includes a substrate 71, a layer of an adhesive composition 72 and a release film 73 . The substrate 71 maybe a thermally conductive, flame retardant and electrically insulating silicone sheet of different hardness. The main component of this thermally conductive silicone sheet may be a siloxane resin, and other additives, such as ceramic powder, are added to be thermally conductive. In this way, the thermally conductive silicone sheet is flexible and, not sticking foreign particles, and closely in contact with the heat source to improve the thermally conductive effect. The substrate 71 may have a thickness between 0.5 mm to 20 mm. Please refer to the above for the details of the adhesive compositions 72.

The adhesive composition 72 covers one side of the substrate 71, and the release film 73 covers the other side of the adhesive composition 72, so that the adhesive composition 72 is sandwiched between the substrate 71 and the release film 73. Tear the release film 73 off to adhere the adhesive composition 72 to a target object (not shown). FIG. 8 illustrate a compressible, flexible, temperature resistant and electrically insulating adhesive sheet 70 of the present invention to be particularly suitable in contact with a heating source whose surface may not be even, such as IC chips.

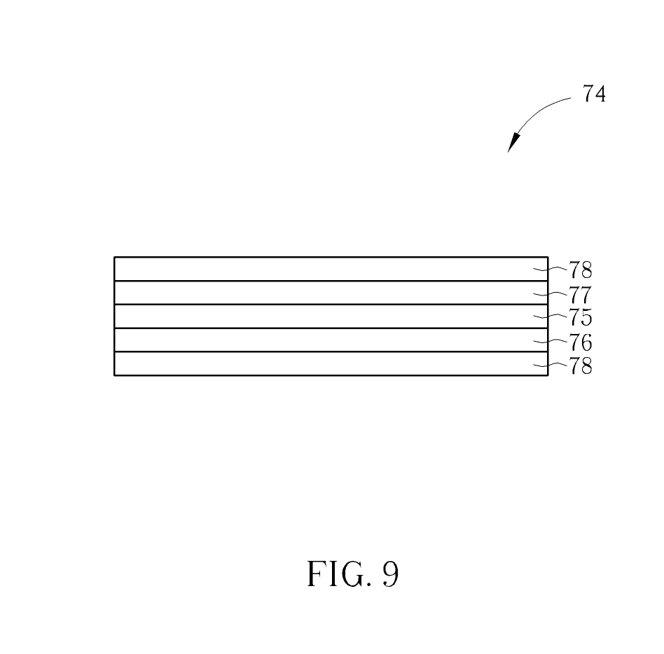

In another embodiment of the present invention, the adhesive of the present invention may form a double-sided adhesive with a substrate. FIG. 9 illustrates an adhesive sheet of the present invention forms a double-sided adhesive with a substrate. The adhesive sheet 74 of the present invention includes a substrate 75, a layer of a first adhesive composition 76, a second adhesive substance 77 and a release film 78. The substrate 75 may be a thermally conductive, flame retardant and electrically insulating silicone sheet of different hardness. The main component of this thermally conductive silicone sheet may be a siloxane resin, and other additives, such as ceramic powder, are added to be thermally conductive. In this way, the thermally conductive silicone sheet is flexible and, not sticking foreign particles, and closely in contact with the heat source to improve the thermally conductive effect.

The compressible, flexible, temperature resistant and electrically insulating adhesive sheet 74 of the present invention is particularly for use in assembling electronic products or in a heating source whose surface may not be even. Please refer to the above for the details of the adhesive compositions 72. Tear the release film 73 off to adhere the adhesive composition 72 to a target object (not shown). Due to its superior adhesion, the target object would not come off or dislocate during transportation or being fetched after the adhesive composition adheres to a target object.

Table 1 summarizes the properties of the single-sided or double-sided adhesive sheets of the present invention formed by the adhesion composition of the present invention with various substrates, in particular low thermal resistance, high temperature resistance, high flame resistance and high voltage resistance. The adhesion composition of the present invention is thermally conductive, electrically insulating, high temperature resistant and flame retardant.

TABLE 1

| | EXAMPLE | EXAMPLE | EXAMPLE | EXAMPLE | EXAMPLE | Test |
|---|---|---|---|---|---|---|
| | 1 | 2 | 3 | 4 | 5 | mode |
| substrate | Fiber glass | Aluminum | — | KAPTON ® | siloxane | |
| | | foil | | | resin | |
| thickness of | 0.1 +/− 0.05 | 0.05~0.25 | 0.05~20 | 0.02~0.15 | 0.1~20 | Thickness |
| the adhesive | | | | | | meter |
| layer (mm) | | | | | | |
| form | single/ | single/ | single/ | single/ | single/ | |
| | double- | double- | double- | double- | double- | |
| | sided | sided | sided | sided | sided | |
| Holding | above 250 | above 250 | above 1 | above 250 | above 1 | ASTM D |
| strength | | | | | | 1000 |
| gf/in² | | | | | | |
| Thermal | below 5 | below 0.6 | below 5 | below 3.5 | below 5 | ASTM D |
| resistance | | | | | | 5470 |
| (° C. · in/watt) | | | | | | |
| volume | above 10⁸ | | above 10⁸ | above 10⁸ | above 10⁸ | ASTM D |
| resistivity | | | | | | 257 |
| (ohm-cm) | | | | | | |
| Breakdown | above 2.0 | | 0.5 | above 5 | 0.5 | ASTM D |
| Voltage (kV) | | | | | | 149 |
| Tensile | above 150 | above 12 | | above 250 | | ASTM D |
| Strength | | | | | | 412 |
| (Kgf/cm²) | | | | | | |
| Elongation | above 2 | above 5 | | above 20 | | ASTM D |
| (%) | | | | | | 412 |
| Operating | −40~180 | −40~180 | −40~180 | −40~180 | −40~180 | |
| temperature | | | | | | |
| (° C.) | | | | | | |
| UL | 94 V-0 | 94 V-0 | 94 V-0 | 94 V-0 | 94 V-0 | UL No. |
| flammability | | | | | | E153203 |
| RoHS | pass | pass | pass | pass | pass | SGS ICP |
| Halogen | pass | pass | pass | pass | pass | SGS |
| content | | | | | | |

Beside, several experiments are conducted to compare the flame retardant property of the commercially available adhesive sheets with those of one of the adhesive sheets disclosed in the present embodiments. The result is shown in Table 2 below.

TABLE 2

| | | | | | | Afterflame | | |
|---|---|---|---|---|---|---|---|---|
| | | | | | | + | | |
| | | THK | Afterflame | cotton | Afterflame | Afterglow | cotton | |
| | # | (mm) | time (s)—1 | burn | time (s)—2 | time (s) | burn | Judgment |
| Commercially | 1 | 0.125 | 38 | X | 25 | 25 | X | UL 94 HB |
| available | 2 | 0.123 | 32 | X | 10 | 12 | X | UL 94 HB |
| adhesive −1 | 3 | 0.122 | 30 | X | 12 | 12 | X | UL 94 HB |
| Commercially | 1 | 0.153 | 24 | V | 20 | 23 | V | UL 94 V-2 |
| available | 2 | 0.152 | 22 | V | 18 | 20 | V | UL 94 V-2 |
| adhesive −2 | 3 | 0.155 | 23 | V | 17 | 20 | V | UL 94 V-2 |
| Commercially | 1 | 0.201 | 8 | X | 10 | 10 | X | UL 94 V-1 |
| available | 2 | 0.210 | 12 | X | 3 | 3 | X | UL 94 V-1 |
| adhesive −3 | 3 | 0.203 | 20 | X | 4 | 5 | X | UL 94 V-1 |
| exemplary | 1 | 0.11 | 4 | X | 2 | 2 | X | UL 94 V-0 |
| embodiment | 2 | 0.105 | 5 | X | 2 | 2 | X | UL 94 V-0 |
| −1 | 3 | 0.105 | 2 | X | 0 | 0 | X | UL 94 V-0 |
| exemplary | 1 | 0.11 | 6 | X | 3 | 3 | X | UL 94 V-0 |
| embodiment | 2 | 0.104 | 8 | X | 1 | 1 | X | UL 94 V-0 |
| −2 | 3 | 0.112 | 8 | X | 2 | 2 | X | UL 94 V-0 |

Specifically, the composition of the exemplary embodiment −1 shown in Table 2 is:
6 wt. % of hydrophilic silicone polymer (Magnasoft SilQ, MOMENTIVE™);
45 wt. % of solvent free silicone polymer (Silopren Gel 8-5900-PSA, MOMENTIVE™ PSA series);
20 wt. % of aluminum oxide;
26 wt. % of aluminum hydroxide; and
3 wt. % of vinyltrimethyl silane.

In addition, the composition of the exemplary embodiment −2 shown in Table 2 is:
6 wt. % of hydrophilic silicone polymer (Magnasoft SilQ, MOMENTIVE™);
48 wt. % of solvent free silicone polymer (Silopren Gel 8-5900-PSA, MOMENTIVE™ PSA series);
20 wt. % of aluminum oxide;
22 wt. % of aluminum hydroxide;
2 wt. % of vinyltrimethyl silane; and
2 wt. % of boron nitride.

In brief, the adhesive sheet of the present invention has the following advantages:
1. Comply with the international standards of UL 94 V-0.
2. Re-workable, re-stickable even after a long period of use.
3. High thermal conductivity (thermal resistance of less than 5° C./Watt) and long-term resistance to high temperature (−40° C. to 150° C.)
4. Insoluble in water, non-hydrolysis, resistant to UV light, sweat, cosmetics and etc.
5. Both single or double-sided products possible, high temperature resistant and flame retardant when in use.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A thermally conductive, electrically insulating, high temperature resistant and flame retardant adhesive sheet, comprising:
a substrate; and
an adhesive layer disposed on the substrate, formed from an adhesive composition, wherein the adhesive composition comprises from 10 to 90 wt. % of a solvent-free and pressure sensitive siloxane resin which is temperature resistant at a temperature of 140° C. to 160° without substantially cracking at 150° C., and the solvent-free and pressure sensitive siloxane resin comprises at least a hydrophilic functional group, wherein the weight percentage of the hydrophilic functional group in the solvent-free and pressure sensitive siloxane resin is in the range of 1 to 10 wt. %;
from 0.01 to 75 wt. % of a metal hydroxide;
from 0.01 to 80 wt. % of a metal oxide; and
from 0.01% to 30% wt. % of a nitride.

2. The thermally conductive, electrically insulating, high temperature resistant and flame retardant adhesive sheet of claim 1, wherein the hydrophilic functional group is selected from the group consisting of a hydroxyl group, a silanol group, a carboxyl group, and an amino group.

3. The thermally conductive, electrically insulating, high temperature resistant and flame retardant adhesive sheet of claim 1 further comprising from 0.01 to 5 wt. % of a coupling agent.

4. The thermally conductive, electrically insulating, high temperature resistant and flame retardant adhesive sheet of claim 3, wherein the coupling agent is a vinyl-based coupling agent.

5. The thermally conductive, electrically insulating, high temperature resistant and flame retardant adhesive sheet of claim 1, wherein the coupling agent is vinyl-tris(2-methoxyethoxy)silane.

6. The thermally conductive, electrically insulating, high temperature resistant and flame retardant adhesive sheet of claim 3, wherein the coupling agent makes a cross-linking reaction between the interface of the siloxane resin and the substrate to have an adhesive function.

7. The thermally conductive, electrically insulating, high temperature resistant and flame retardant adhesive sheet of claim 1, wherein the metal hydroxide comprises at least one of aluminum hydroxide and magnesium hydroxide.

8. The thermally conductive, electrically insulating, high temperature resistant and flame retardant adhesive sheet of claim 1, wherein the metal oxide is in the form of flakes or is irregular or spherical in shape, and selected from the group consisting of at least one of alumina, zinc oxide and magnesium oxide.

9. The thermally conductive, electrically insulating, high temperature resistant and flame retardant adhesive sheet of claim 1, further comprising from 0.01 to 3 wt. % of aluminum powder.

10. The thermally conductive, electrically insulating, high temperature resistant and flame retardant adhesive sheet of claim 9, wherein the aluminum powder has an average particle size of 1 to 20 μm.

11. The thermally conductive, electrically insulating, high temperature resistant and flame retardant adhesive sheet of claim 1, wherein the adhesive sheet is in the form of a double-sided adhesive sheet comprising:
the substrate having a first side and a second side;
a first adhesive layer formed from the adhesive composition which covers the first side; and
a second adhesive layer formed from the adhesive composition which covers the second side so that the substrate is sandwiched between the first and second adhesive layers.

12. The thermally conductive, electrically insulating, high temperature resistant and flame retardant adhesive sheet of claim 1, wherein the adhesive sheet is in the form of a single-sided adhesive sheet in which:
the substrate covers a first side of the adhesive layer; and
the release film covers a second side of the adhesive layer so that the adhesive layer is sandwiched between the substrate and the release film.

13. The thermally-conductive, electrically insulating, high temperature resistant and flame retardant adhesive sheet of claim 1, wherein the adhesive layer has a thermal resistivity less than 5° C./watt.

14. The thermally conductive, electrically insulating, high temperature resistant and flame retardant adhesive sheet of claim 1, wherein the adhesive layer has a volume resistivity greater than 10⁸ ohm-cm.

15. The thermally conductive, electrically insulating, high temperature resistant and flame retardant adhesive sheet of claim 1, wherein the adhesive layer is rated to the standard of UL 94V-0.

16. A method of fabricating a thermally conductive, electrically insulating, high temperature resistant and flame retardant adhesive sheet, comprising:
providing a substrate;
coating at least a layer of vinyl-functional coupling agent on the surface of the substrate;
preparing a mixture comprising a solvent-free siloxane resin, a metal hydroxide and a metal oxide, wherein the solvent-free siloxane resin comprises at least a hydrophilic functional group, and the weight percentage of the hydrophilic functional group in the solvent-free siloxane is in the range of 1 to 10 wt. %;
coating a layer of the mixture on the substrate after the step of coating the layer of the vinyl-functional coupling agent; and
heating the substrate at 80° C. for 30 minutes after the step of coating the layer of the mixture.

17. The method of fabricating the thermally conductive, electrically insulating, high temperature resistant and flame retardant adhesive sheet of claim 16, wherein a viscosity of the solvent-free siloxane resin is in the range of 20 to 50 Pa·s.

18. The method of fabricating the thermally conductive, electrically insulating, high temperature resistant and flame retardant adhesive sheet of claim 16, wherein the hydrophilic functional group is selected from the group consisting of a hydroxyl group, a silanol group, a carboxyl group, and an amino group.

19. The method of fabricating the thermally conductive, electrically insulating, high temperature resistant and flame retardant adhesive sheet of claim 16, wherein the vinyl-functional coupling agent is vinyl-tris (2-methoxyethoxy) silane.

20. The method of fabricating the thermally conductive, electrically insulating, high temperature resistant and flame retardant adhesive sheet of claim 16, wherein the thermally conductive, electrically insulating, high temperature resistant and flame retardant adhesive sheet is rated to the standard of UL 94V-0.
